(19) United States
(12) Patent Application Publication
(10) Pub. No.: US 2002/0043426 A1
(43) Pub. Date: Apr. 18, 2002

(54) Modular ladder assembly for mine raise and kit therefor

(76) Inventors: Marcelin Bruneau, Montbeillard (CA); Louis-Georges Lemire, Rouyn-Noranda (CA)

Correspondence Address: LESPERANCE & MARTINEAU, 1440 WEST, STE-CATHERINE ROOM 700, MONTREAL, QC, H3G1R8, CA

(21) Appl. No.: 09/925,491

(22) Filed: Aug. 10, 2001

Related U.S. Application Data
(63) Continuation-in-part of application No. 09/381,590, filed on Sep. 22, 1999, now abandoned.
(60) Provisional application No. 60/044,654, filed on Mar. 28, 1997.

(51) Int. Cl. E06C 7/16

(52) U.S. Cl. 182/103; 182/151

(57) ABSTRACT

The kit is used for the assembly of a modular ladder assembly in an ascending mine raise having a peripheral wall. The kit includes:

a plurality of crossbars adapted to be installed transversely inside the mine raise, each crossbar including a length adjustment device and anchoring members for releasably anchoring the crossbars to the mine raise peripheral wall;

a plurality of elongated ladder sections, each ladder section defining two opposite ends and including:

a first ladder section attachment member adapted to releasably attach in use the ladder section to a corresponding crossbar installed inside the mine raise, whereby a first ladder section attachment point is obtained, the first ladder section attachment member being carried at one of the ladder section ends;

a second ladder section attachment member adapted to releasably attach in use the ladder section to either one of an adjacent crossbar and an adjacent ladder section whereby a second ladder section attachment point is obtained, the second ladder section attachment member being located at the ladder section end opposite the first ladder section attachment member. The kit is adapted in use to form a ladder assembly inside the mine raise by the co-extensive installation of a number of ladder sections supported by crossbars.

### CROSS-REFERENCE DATA

This patent application is a continuation-in-part of co-pending U.S. patent application Ser. No. 09/381,590 filed on Sep. 22, 1999.

### FIELD OF THE INVENTION

The invention relates to a modular ladder assembly, and more particularly to a modular ladder assembly for use in a mine raise.

### BACKGROUND OF THE INVENTION

Several large machines or apparatuses are used to drill mine raises, especially very long mine raises (e.g. usually 500 feet to 1000 feet). In such cases where the mine raises are long, the money and energy expenses for carrying the machine through the mine tunnels are rewarded by the efficient work of the machine. However, approximately 9 out of 10 mine raises are of smaller size, often less than 200 feet long. In such cases, the use of larger machines is not called for, because it would often prove too expensive to carry the machine into the tunnels to mine a 200 foot raise. In the case of these smaller raises, many miners build a home-made ladder assembly on the site out of timber. However, this becomes eventually expensive, since the timber can only be used once, in a particular mine raise, and afterwards becomes obsolete. New timber must thus be bought for each new raise in which a ladder assembly must be built, because the old timber is not likely to fit into a new mine raise, and because it is likely that it would be damaged when trying to remove it from the previous raise. Also, the timber is not a material which is reliable enough in the mining operations, considering the explosions that occur in the mine raise and the falling rock fragments that result therefrom. Indeed, the structural integrity of the timber can be significantly compromised by large rock fragments falling in the mine raise thereon. Also, and most importantly, the miners themselves can be seriously injured or killed by falling rock fragments, since the timber-made ladder assembly can become easily disassembled from falling rock impact loads, and offers an unreliable protection.

### SUMMARY OF THE INVENTION

The present invention relates to a modular ladder assembly for upwardly inclined mine raises of the type having an open corridor with upper and lower ends and an irregular inner peripheral rock wall, comprising:

a number of transverse support members having a selectively operable length adjustment device;

anchoring members, for adjustable and releasable transverse attachment of said support members to the mine raise irregular peripheral rock wall in vertically spaced-apart, successive fashion;

a number of elongated ladder sections defining upper and lower ends and each being positioned adjacent at least one said support member;

ladder sections attachment members, integral to a selected one of each said ladder section and each said support member, each said ladder sections attachment member releasably attaching each said ladder section to a corresponding said support member;

a first coupling member, integral to the upper end of each said ladder section; and

a second coupling member, integral to the lower end of each said ladder section and matingly releasably attachable to said first coupling member of an underlying other said ladder section;

wherein a continuous ladder assembly can be gradually formed in a mine raise by end to end attachment of successive said ladder sections, with said crossbars supporting said ladder sections, and wherein said ladder assembly can be removed from said mine raise to be used in other mine raises.

Preferably, said support members are transverse elongated cross-bars having two opposite ends having attachment portions for fixed attachment thereof to the mine raise peripheral rock wall.

Preferably, said length adjustment device of each said cross-bar includes at least two portions in said cross-bar that are telescopingly engaged.

Preferably, each said cross-bar includes a main elongated sleeve bar having two opposite open ends and a first and a second bars slidable inside said sleeve bar and outwardly extending through a corresponding one of said first and second open ends; and fixing members for selectively releasably setting the respective positions of said arms relative to said sleeve bar.

Preferably, the length of each said ladder section can be selectively adjusted.

Preferably, each said ladder section has a pair of opposite lateral studs defining upper and lower end portions and a plurality of spaced transverse rungs, and further including an intermediate sleeve member wherein said upper and lower end portions of said ladder section studs are slidable in said sleeve member and extend upwardly and downwardly thereof respectively; and further comprising fixing members for selectively releasably setting the respective positions of said upper and lower end portions of said ladder sections relative to said sleeves.

Preferably, said ladder attachment members are brackets formed of flat rigid C-shaped plates fixedly attached to the upper end of each said ladder section, for secure abutment of said ladder section against a corresponding cross-bar, with each said cross-bar having a rectangular cross-section to allow said brackets to matingly abut complementarily thereover in a hooking fashion, whereby the downward engagement of said C-shaped bracket over and partly around an underlying said cross-bar prevents movement of said ladder section relative to said cross-bar in all directions except upwardly lengthwisely of the ladder section.

Preferably, a complementary pair of said first and second coupling members each comprises a corresponding one of a female and a male end matingly engageable with each other in a releasable attachment that allows relative angular positioning of two successive ladder sections attached to each other about an axis substantially parallel to an adjacent said cross-bar.

Preferably, the ladder assembly further comprises:

a number of integral pairs of spaced parallel elongated rail sections, each of said pairs defining upper and lower ends and being positioned adjacent at least one said support member;

rail attachment members attached to either one of each said pairs of rail sections and each said support members, for removably attaching each said pairs of rail sections to a corresponding said support member;

a third coupling member attached to the upper end of each said pair of rail sections;

a fourth coupling member attached to the lower end of each said pair of rail sections and matingly releasably attachable to said third coupling member of an underlying rail section;

whereby a continuous modular rail can be formed by a number of rail sections releasably attached to one another in successive pairs coupled end to end, said continuous rail being secured to said support members by said rail attachment members; said ladder assembly further comprising:

a carriage movable along said rails, said carriage including a load carrying housing; and

a carriage displacement device, for supporting and moving said carriage along said continuous rail.

Preferably, said third and fourth coupling members include pivots allowing relative angular positioning of two successive pairs of rail sections about an axis substantially parallel to and adjacent said support member.

Preferably, said carriage comprises a main body and a pair of sliders attached to said main body and engaging said continuous rail so as to be movable therealong, and wherein each rail section of a said integral pair of rail sections has longitudinally inturned flanges that cradle over one of said carriage sliders for preventing accidental disengagement of said carriage sliders from said rails while allowing free sliding movement of said sliders along said continuous rail.

Preferably, said carriage main body defines first and second opposite ends and comprises a pair of link arms each pivotally attached to both said main body first end and to a corresponding said carriage slider, and wherein said displacement device is a cable attached to a top end of said carriage for upwardly pulling said carriage along said rails.

Preferably, said carriage comprises an emergency braking system, for preventing high velocity downward movement of said carriage upon accidental rupture or release of said cable.

Preferably, said ladder assembly further comprises a flexible protective screen, edgewisely attached to each said support member and freely hanging therefrom, for protecting the ladder assembly therebehind from falling rocks or other debris detaching from the peripheral rock wall ahead thereof.

Preferably, said protective screen comprises several vertical panel members edgewisely interconnected in successive pairs to form a substantially flat modular protective screen, whereby the length of said protective screen may be adjusted in accordance with the size of the ladder assembly by selecting the number of panel members forming said protective screen.

Preferably, said ladder assembly further comprises a safety sheet net releasably carried by and horizontally extending from the uppermost support member so as to extend substantially horizontally.

The present invention also relates to a kit for the assembly of a modular ladder assembly in an ascending mine raise having a peripheral wall, said kit comprising:

a plurality of crossbars adapted to be installed transversely inside the mine raise, each said crossbar including a length adjustment device and anchoring members for releasably anchoring said crossbars to the mine raise peripheral wall;

a plurality of elongated ladder sections, each said ladder section defining two opposite ends and comprising:

a first ladder section attachment member adapted to releasably attach in use said ladder section to a corresponding said crossbar installed inside the mine raise, whereby a first ladder section attachment point is obtained, said first ladder section attachment member being carried at one of said ladder section ends;

a second ladder section attachment member adapted to releasably attach in use said ladder section to either one of an adjacent said crossbar and an adjacent said ladder section whereby a second ladder section attachment point is obtained, said second ladder section attachment member being located at said ladder section end opposite said first ladder section attachment member;

wherein said kit is adapted in use to form a ladder assembly inside the mine raise by the co-extensive installation of a number of said ladder sections supported by said crossbars.

The invention further relates to a kit for the assembly of a modular ladder assembly in an ascending mine raise having a peripheral wall and an upper end, said kit comprising:

a plurality of crossbars adapted to be installed transversely inside the mine raise, each said crossbar including a length adjustment device and anchoring members for releasably anchoring said crossbars to the mine raise peripheral wall;

a plurality of elongated ladder sections, each said ladder section defining first and second opposite ends and comprising:

a ladder section attachment member carried at said ladder section first end adapted to releasably attach in use said ladder section to a corresponding said crossbar installed inside the mine raise;

a first coupling member integrally attached at said ladder section first end; and

a second coupling member integrally attached at said ladder section second end and adapted to releasably engage in use said first coupling member of another ladder section for releasable attachment of said first and second coupling members;

wherein said kit is adapted in use to form a ladder assembly inside the mine raise by the co-extensive installation of a number of said ladder sections releasably attached to one another in end to end relationship and supported by said crossbars.

Preferably, the length of each said ladder section is adjustable.

Preferably, said kit further comprises a plurality of protective screens adapted in use to each be attached to a corresponding crossbar to freely hang therefrom for protecting an adjacent ladder section from falling debris.

### BRIEF DESCRIPTION OF THE DRAWINGS

In the annexed drawings:

FIG. 1 is a perspective view of an intermediate portion of a mine raise in which an intermediate portion of a modular ladder assembly according to the invention is installed;

FIGS. 2 and 3 are front and side edge elevations, respectively, of the mine raise and ladder assembly intermediate portions of FIG. 1;

FIG. 4 is an enlarged front elevation of the upper and lower portions of a pair of vertically successive ladder sections attached to each other, together with a portion of a transverse cross-bar on which a ladder section rests;

FIG. 5 is an exploded perspective view of the elements of FIG. 4 at a slightly smaller scale;

FIG. 6 is a rear perspective view, at an enlarged scale, of the upper and lower portions of two vertically successive pairs of rail sections attached to each other, together with a portion of a transverse cross-bar on which a pair of rail sections rests;

FIG. 7 is a cross-sectional view of a section of the ladder assembly carriage, at an enlarged scale, showing more particularly the carriage guide arm and slider with a rail section;

FIG. 8 is a perspective view, at an enlarged scale, of the front end of the equipment carriage of the invention, showing more particularly the emergency braking system thereof;

FIG. 9 is an enlarged side cross-section of the braking system of the invention; and

FIG. 10 is a perspective view of a safety net which is to be installed at the upper end of the modular ladder assembly.

### DETAILED DESCRIPTION OF THE PREFERRED EMBODIMENTS

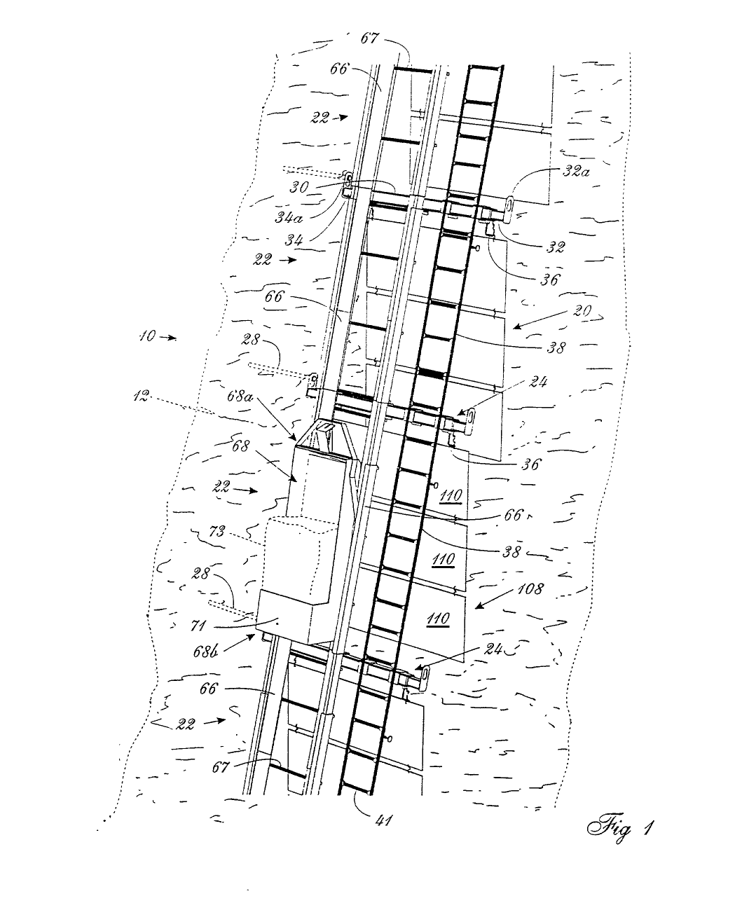

FIGS. 1-3 show a conventional mine raise 10, or any similar open corridor or shaft made in rock or the like solid material. The mine raise 10 is vertical or vertically inclined (i.e. upwardly inclined so as to have an at least partially vertical orientation), as known in the art of mining. The mine raise comprises a lower end (not shown) destined to allow access into the mine raise from another usually horizontal tunnel (not shown), an upper end (not shown) where mining operations are to be accomplished, and an inner peripheral wall 12 circumscribing the mine raise per se. The mine raise is formed by drilling an elongated hollow channel made through the rock by means of explosives or other known means, and thus it is likely to have a rather irregular surface of varying shape and diameter, as suggested in the drawings; and may also have a varying orientation. A work platform (not shown) is installed at the upper end of the mine raise, for allowing miners to accomplish the drilling and mining operations thereon.

Inside mine raise 10 is installed a modular ladder assembly 20 according to the invention, which allows access from the bottom end of the mine raise to the work platform at the upper end thereof. Since mine raise 10 has an evolving length as the mining operations are accomplished, ladder assembly 20 likewise has an adjustable length, as will be detailed hereinafter.

Ladder assembly 20 comprises a number of tiers 22 arranged in vertically successive fashion and destined to be gradually installed in the mine raise from the lower end to the upper end thereof, for allowing miners to climb therealong to reach the upper end of the mine raise to accomplish the mining operations. Thus, as the mine raise length increases, additional tiers 22 of the ladder assembly are added gradually over the preceding ones, so as to progressively increase the length of the ladder assembly 20 so that the ladder assembly 20 follow the evolution of the mine raise 10.

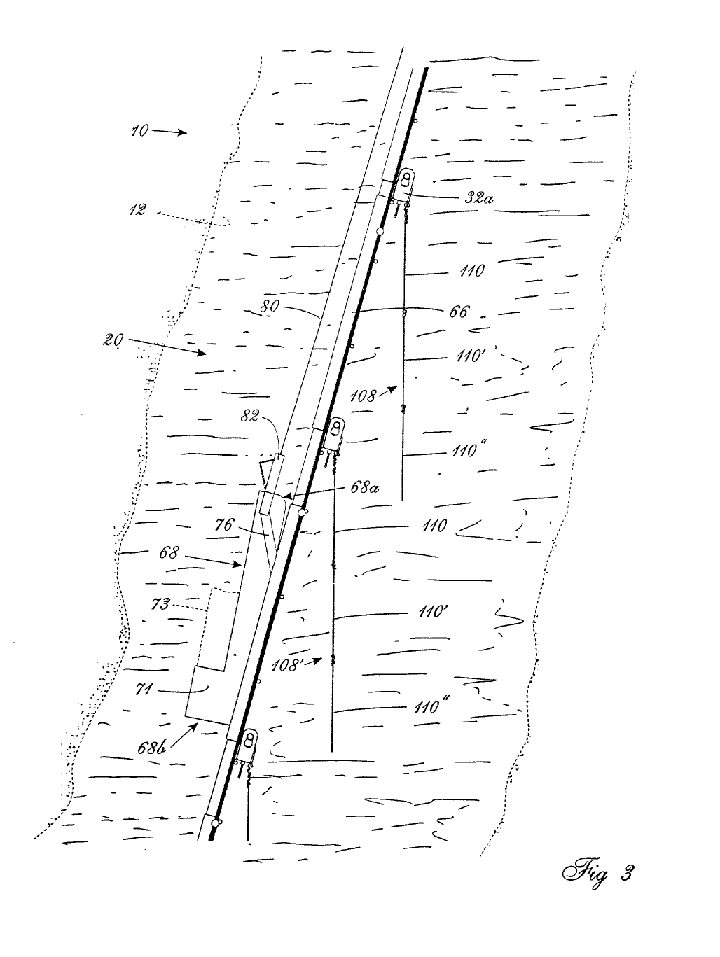

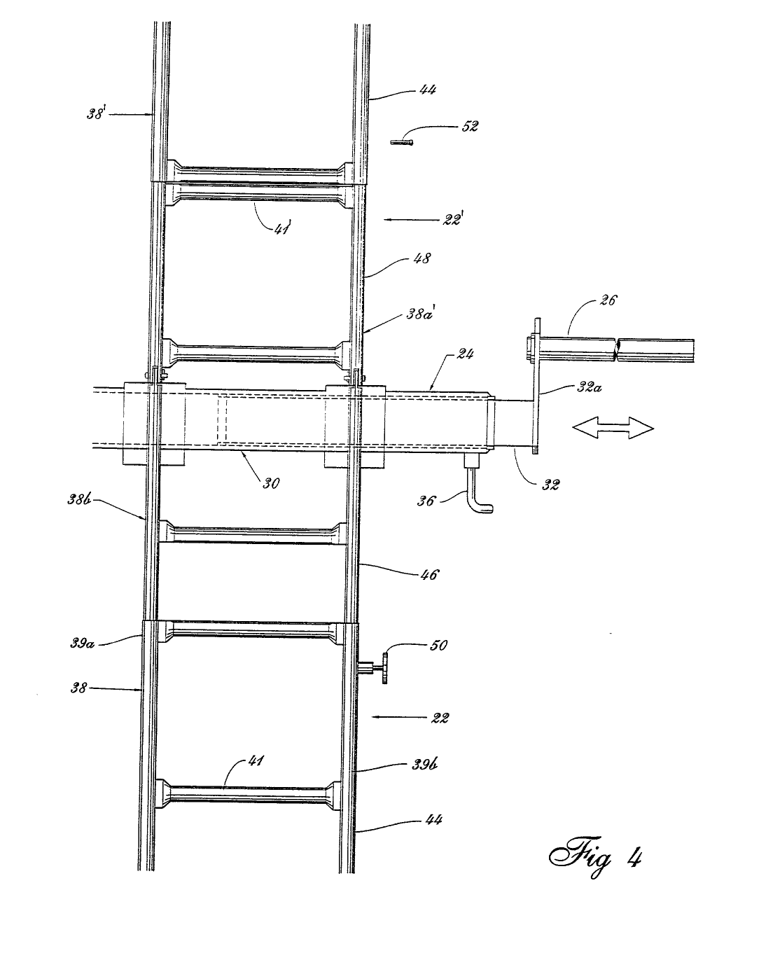

FIGS. 1, 2, 4 and 5 show that each tier 22 comprises an elongated transverse cross-bar 24, which is releasably transversely attached to the mine raise peripheral wall 12 by means of elongated tie rods 26, 28 located at each of the two opposite ends of cross-bar 24. Each cross-bar 24 has a main elongated hollow sleeve bar 30 having two opposite open ends and a first and a second bars 32, 34 axially slidable inside sleeve bar 30 and outwardly extending through a corresponding one of the sleeve bar 30 first and second open ends, so as to form cross-bar length adjustment means. Set screws 36, 37 (FIGS. 4-5) are provided near each of the first and second ends of sleeve bar 30 through threaded bores therein, so as to releasably independently set the respective positions of bars 32, 34 relative to sleeve bar 30. The outer free extremities of bars 32, 34 are provided with integral transverse bored ears 32a, 34a that are engaged by rods 26, 28 to fixedly and releasably anchor cross-bars 24 to wall 12.

The length of cross-bars 24 can be adjusted to fit variable horizontal or transverse widths of open vertical channels formed along mine raise 10, by the selective independent adjustment of bars 32, 34 in sleeve bar 30. This is highly desirable, since the inner peripheral wall 12 of the mine raise has a varying inner diameter and shape. Furthermore, the fact that cross-bars 24 may be adjusted at each of its extremities allows an easier length adjustment thereof on the site.

FIGS. 4-6 show the lower and upper ends of a pair of vertically successive tiers 22, 22′ of ladder assembly 20, each tier 22, 22′ comprising an elongated ladder section 38, 38′ of adjustable length having a lower end 38a′ and an upper end 38b. Each ladder section 38, 38′ also has a pair of downwardly-opening C-shaped brackets 40, 42 that are fixedly attached (e.g. welded) at its upper end 38b. Brackets 40, 42 are destined to engage and rest on the top portion of the corresponding cross-bar 24 of the same tier 22 for support of the ladder section 38 on cross-bar 24 in an assembled state of ladder assembly 20. Each cross-bar 24 has a rectangular cross-section, and preferably a square cross-section, and brackets 40, 42 are correspondingly and matingly C-shaped (FIG. 5) to snugly engage and rest on a corresponding cross-bar 24. Thus, with such a corresponding rectangular configuration of the cross-bar 24 and brackets 40, 42, the ladder section 38 is prevented from accidental rotational movement around cross-bar 24, and from accidental translational movement in any direction except to downwardly engage cross-bar 24 as suggested with arrow A1 in FIG. 5, and to disengage cross-bar 24 in a direction opposite arrow A1.

FIG. 4 shows that each ladder section 38, 38′ includes opposite parallel laterals studs 39a, 39b, and transverse rungs 41, 41′ integral to studs 39a, 39b. Brackets 40, 42 are fixedly attached at the upper ends of studs 39a, 39b, respectively.

FIGS. 4-5 show that each ladder section 38 comprises an elongated intermediate sleeve 44 and upper and lower end portions 46, 48 slidable in sleeve 44 and extending upwardly and downwardly thereof respectively, thus defining length adjustment means on each ladder section 38. Upper and lower end portions 46, 48 have fixing means in the form of a fixing knob 50 and a fixing pin 52 respectively, to releasably fix the selected length of ladder section 38. Thus, the length of a ladder section 38 can be adjusted between a first minimum ladder section limit length wherein both the upper and lower end portions 46, 48 are retracted in sleeve 44 until two vertically successive rungs 53a, 53b of a ladder section 38 abut against each other (FIG. 5); and a second maximum limit length in which both the upper and lower end portions 46, 48 are partly extracted out of sleeve 44 so that rungs 53a, 53b are spaced from each other of the same distance than that between two vertically successive rungs of intermediate sleeve 44.

FIG. 5 shows that the upper end 38a of each ladder section 38 has a first coupling member in the form of a pair of flat upwardly extending and transversely bored male fingers 54, 56 which matingly engage complementary U-shaped transversely bored female slot adapters 58, 60 located on the lower end 38b of the upwardly successive ladder section 38; female adapters 58, 60 forming a second coupling member. Bolts or pins 62, 64 can releasably attach the first and second coupling members to one another, so that the two successive ladder sections 38, 38′ be releasably attached to one another in end to end pivotable fashion. This pivotable attachment allows the relative angular position of two successive ladder sections 38, 38′ to be selectively adjusted according to their respective positions on their respective crossbars. The transverse orientation of the bored male and female adapters 54, 56, 58, 60 allow both ladder sections 38, 38′ (FIG. 5) to pivot relative to each other around bolts 62, 64, which are oriented parallel to the adjacent cross-bar 24 due to the specific shape of brackets 40, 42 engaging cross-bar 24, which allows a substantially flat, perpendicular relationship between ladder sections 38, 38′ and an adjacent cross-bar 24.

Thus, it can be seen that the relative angular position of two successive ladder sections 38, 38′ can be selectively adjusted due to the pivotal engagement of the first and second coupling members linking ladder sections 38, 38′. This angular adjustment of two successive ladder sections 38, 38′ allows ladder assembly 20 to be assembled in a non-rectilinear fashion, to compensate alignment differences between two vertically successive tiers 22, 22 which can be due for example to an irregular shape or axial orientation of the mine raise channel inner peripheral wall 12.

Also, the cross-bars 24 are preferably rollably mounted in the mine raise peripheral wall 12, i.e. they can pivot around anchor rods 26, 28. This rollable mounting allows the cross-bars 24 to compensate for differences in the inclination of the attached ladder section 28 without having to remove the latter nor install same again at a proper angle.

A continuous modular ladder is thus formed in the mine raise by a number of successive ladder sections 38 releasably attached to one another in end to end coupling fashion, the continuous ladder being secured at regular intervals to the support members 24 by the brackets 40, 42 that form ladder attachment means. The ladder assembly 20 is assembled by installing a first tier 20 at the lower end of the mine raise 10, and then gradually adding a number of tiers 22, 22′, . . . , thereover one after the other, by releasably attaching the first and second coupling members 54, 56 and 58, 60 of each two vertically successive ladder sections 38, 38 and by the bracket members 40, 42 engaging respective cross-bars 24.

The present invention also relates to a kit for the assembly in a shaft or tunnel, of a ladder assembly. This kit includes, in a disassembled condition, a number of ladder sections 38 and a number of cross-bars 24 as described hereinabove. This kit is used for installation of the ladder assembly 20 in a mine raise, gradually using a number of tiers according to the evolving length of the mine raise. Once work in one specific mine raise is over, the ladder assembly can be disassembled and the kit can be re-used in another mine raise to install a ladder assembly.

The present invention also comprises a method of erecting a modular ladder assembly 20 in mine raise 10. The method comprises the steps of:

a) adjusting the length of a first cross-bar 24 to the horizontal width of the mine raise vertical open channel near the lower end thereof;

b) attaching the first cross-bar 24 to the peripheral wall 12 of the mine raise 10 with tie rods 26, 28;

c) attaching a first ladder section 38 to the first cross-bar 24 with brackets 40, 42 which are fixed to ladder section 38 and which engage and rest on cross-bar 24;

d) adjusting the length of another cross-bar 24 to the horizontal width of the mine raise vertical open channel at a position therein over the preceding cross-bar and at a distance therefrom at least equal to the first limit length of a ladder section 38, but no greater than the second limit length of a ladder section 38;

e) attaching said another cross-bar 24 to the peripheral wall 12 of the mine raise at this latter position therein;

f) attaching another ladder section 38 to said another cross-bar 24 with brackets 40, 42 and attaching said another ladder section 38 to the preceding ladder section 38 with their adjacent first and second coupling members releasably engaging each other, while adjusting the length of said another ladder section so that it extends between the upper end of the preceding ladder section 38b and said another cross-bar 24; and

g) repeating steps (d) to (f) inclusive for additional successive cross-bars and ladder sections, until the desired height has been reached with the modular ladder assembly inside the mine raise 10.

Thus, with this method for assembling the ladder assembly 20, each tier 22 is positioned over the preceding tier 22, while work can be accomplished inside the mine raise between the installation of two vertically successive tiers 22.

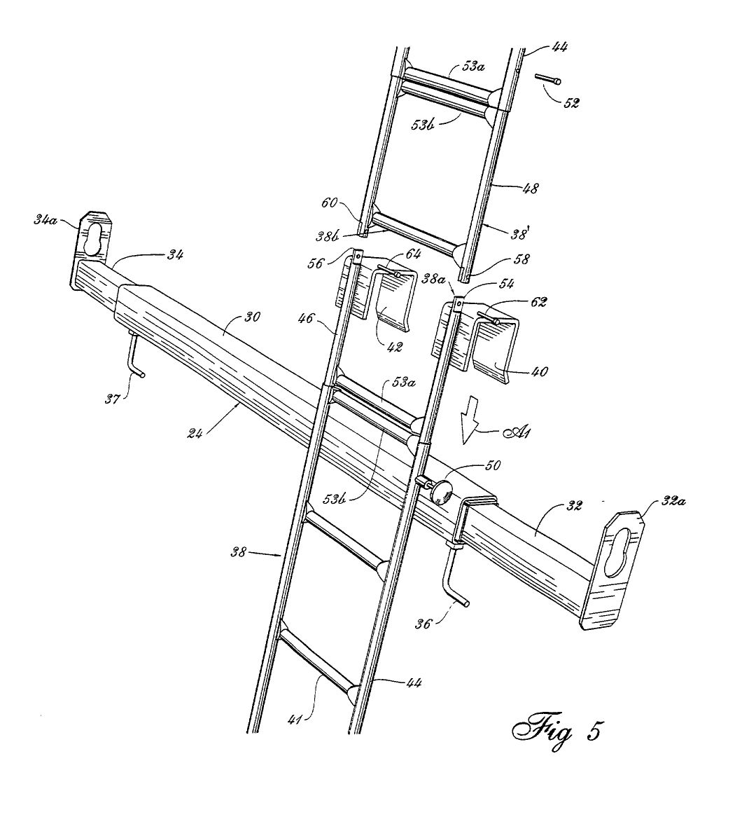

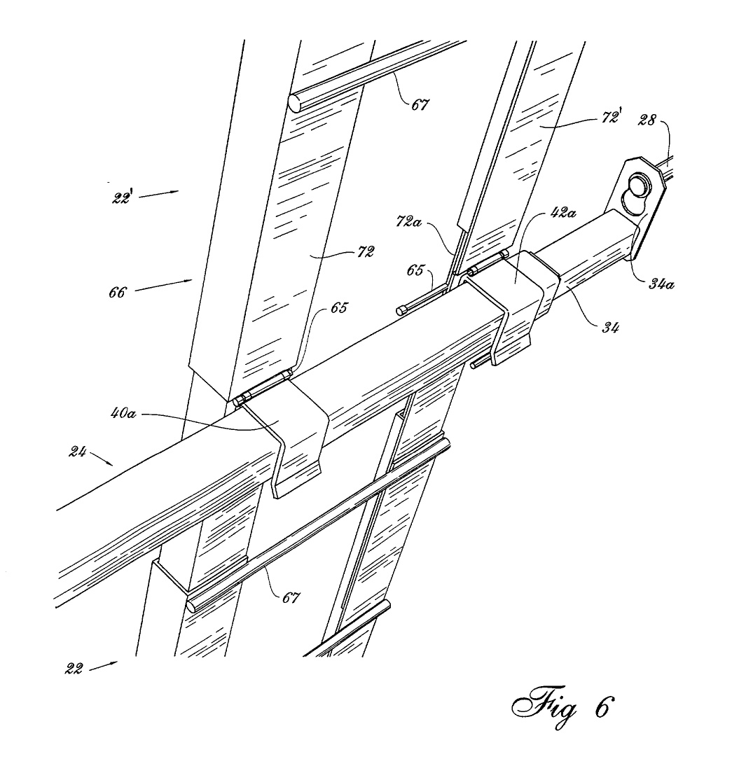

FIGS. 1 to 3 and 6 show that the ladder assembly 20 further comprises a number of integral pairs of spaced parallel elongated rail sections 66 each comprising two elongated tubular rail sections 72, 72′ and a number of transverse cylindroid rungs 67 integrally linking rails 72, 72′. Each pair of rail sections 66 is installed next to the continuous ladder formed by ladder sections 38, along cross-bars 24 and perpendicular thereto. The pairs of rail sections 66 are installed in end to end fashion in a similar manner than ladder sections 38, i.e. they are pivotally linked at their upper ends with the lower end of the upwardly successive pair of rail sections 66 in a secure but releasable fashion at 65, 65, so that they be pivotable around an axis parallel to an adjacent cross-bar 24 to compensate inclination differences between two vertically successive tiers 22, 22′. The pairs of rail sections 66 thus form a continuous rail along the mine raise length. Length adjustment means are also provided on each pair of rail section 66, for adjusting the length thereof; two co-extensive rail sections 72, 72a (FIGS. 6-7) sliding in each other are provided, with one rail extendable beyond the length of the first rail, and with both rails being fixable relative to each other with knobs or the like fixing devices (not shown). Thus, the length of pairs of rail sections 66 can be adjusted to fit corresponding lengths between two successive cross-bars 24, within a limit range which is at least equal to the limit range of the length adjustment of ladder sections 38. The pairs of rail sections 66 are fixed to cross-bars 24 in a similar fashion than ladder sections 38, i.e. C-shaped brackets 40a, 42a (FIG. 6) are provided on the back of the rail section 72, 72 of a pair of rail sections 66 and at the top end thereof, to engage and rest on a corresponding cross-bar 24.

As shown in FIGS. 1-3, ladder assembly 20 further comprises a carriage 68 which defines an upper leading end 68a and a downward trailing end 68b, and comprises a box-like rear housing 71 at its trailing end 68b for supporting miscellaneous mining equipment 73 therein to be carried to the top of the ladder assembly 20. Carriage 68 further comprises a pair of sliders 70, 70, for sliding engagement of carriage 68 in rail sections 72, 72. FIG. 7 shows that each slider 70 slidably engages one rail 72 of a pair of rail sections 66, in such a way as to be craddled therein by the inturned flange 74 thereof for longitudinal sliding engagement of the slider 70 in rail 72. Each slider 70 is further pivotally attached to one end 76a of a link arm or guide arm 76 (FIGS. 3, 7, 8) by means of a bolt 77, and spaced therefrom by means of a spacer nut 78, for allowing inturned flange 74 to be maintained between slider 70 and link arm 76. Link arms 76, 76 are further pivotally attached by their opposite ends 76b to the side walls of carriage 68, so that carriage 68 be movable away from the plane intersecting both rail sections 72, 72 when sliding thereon upon link arms becoming more perpendicular relative to rail sections 72, 72, while carriage 68 remains attached in a slidable fashion by means of sliders 70, 70.

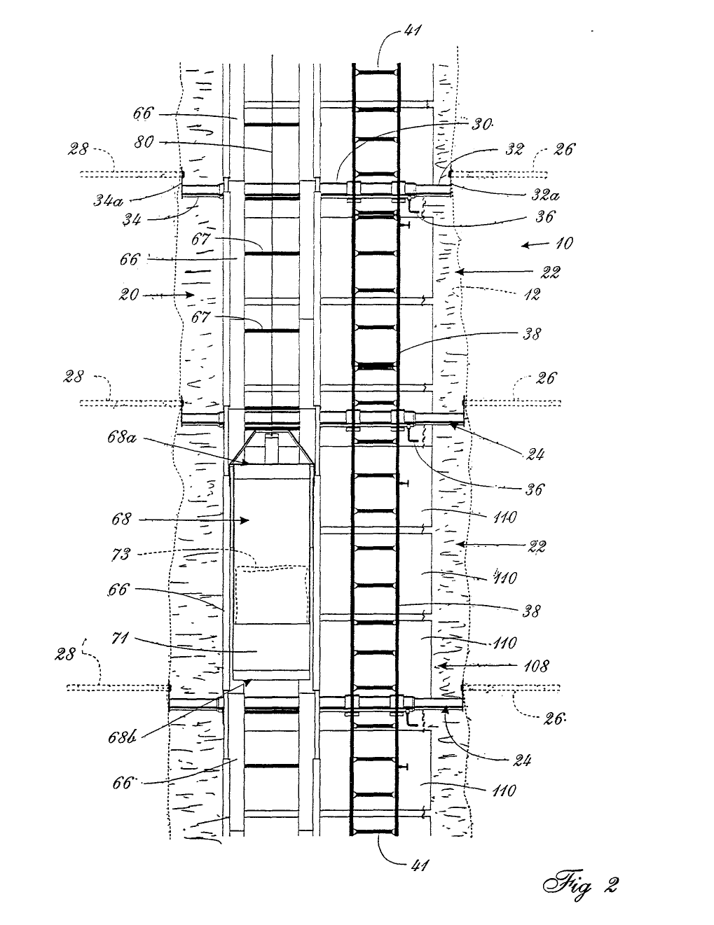

As shown generally in FIGS. 2 and 3, a pulling cable 80 is attached to the upper leading end of carriage 68, and a motor winch (not shown) is provided at the top end of ladder assembly 20 for pulling carriage 68. Alternately, the motor winch can be provided at the bottom end of ladder assembly, with a pulley at the top end thereof.

In use, link arms 76, 76 will help prevent carriage 68 from getting stuck between two vertically successive pairs of rail sections 66, 66 having different inclinations. Indeed, link arms 76, 76 will allow the carriage upper leading end 68a to move away from or closer to the rail sections 72, 72, to in turn allow the cable 80 to pull on carriage 68 in a more perpendicular fashion, so as to compensate for angular variations of two vertically successive rail sections 66, 66.

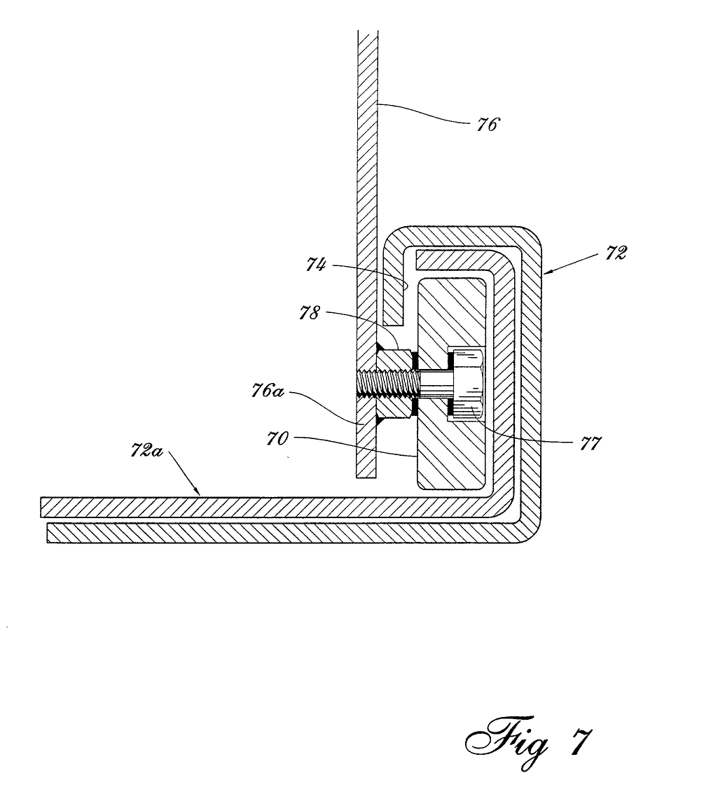

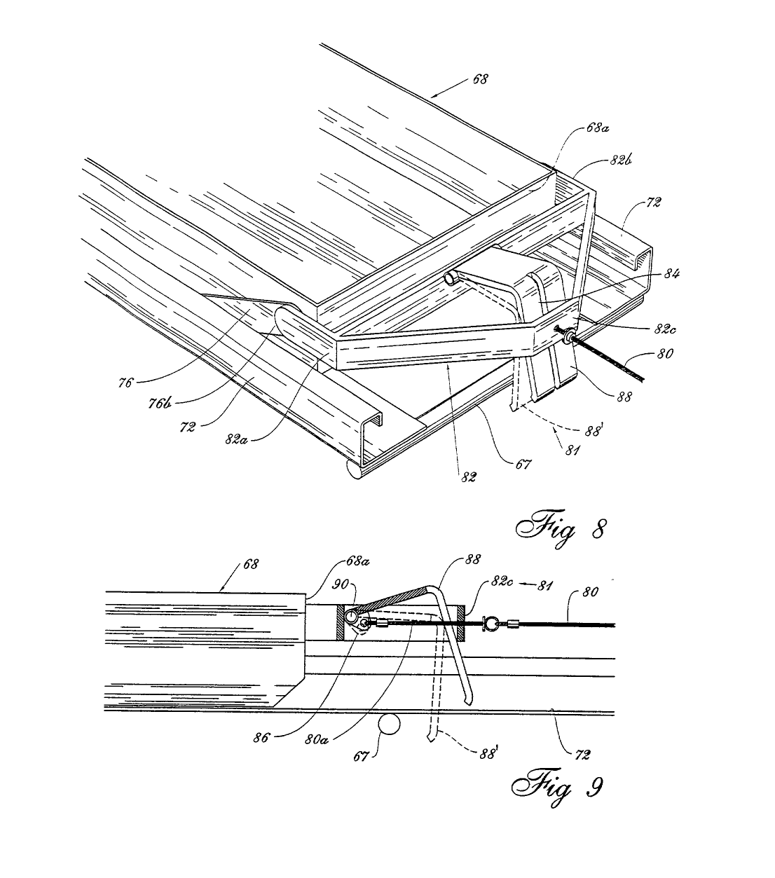

FIGS. 8 and 9 disclose an emergency braking system 81 which comprises a V-shaped alignment arm 82 fixedly attached to the carriage leading end 68a at both its extremities 82a, 82b for spacedly positioning its web portion 82c ahead of carriage leading end 68a, the U-shaped arm web portion 82c being bored for allowing aligned through-passage of the pull end of cable 80. A sleeve (not shown) can be provided in the through-bore of the arm web 82c to prevent premature shearing wear of cable 80. Cable 80 is attached to a pivot finger 86 which is in turn integrally attached to a L-shaped braking arm 88, both of them being pivotally attached at 90 to the carriage leading end 68a, so that braking arm 88 be pivotable between a first unobstructive and inoperative position, shown in FIGS. 8-9 as reference number 88, and a second operative rail rung-engaging position shown in FIGS. 8-9 in dotted lines with reference number 88′. A torsion spring (not shown) should be provided around the pivot axle 90 to continuously bias braking arm 88 in its operative position. The purpose of cable 80 passing through the alignment arm web 82c is to provide a straight, motionless section 80a to cable 80, cable section 80a extending between alignment arm web 82c and the attachment point of cable 80 to carriage 68 on a pivot finger 86, to allow cable 80 to engage a slot 84 made in braking arm 88 without interfering with the pivoting displacement of arm 88 towards its said operative position.

In use, carriage 68 is to be supported by cable 80 at all times, either when being pulled upwardly towards the top of ladder assembly 20, or when being lowered to the bottom end thereof. Thus cable 80 always supports the load of carriage 68, and always pulls on pivot finger 86 to bias braking arm 88 in its inoperative position. However, under sudden and accidental release or rupture of cable 80 due to a defective winch, wear of cable 80 or any other reason, the cable 80 would no longer pull on pivot finger 86, and thus the torsion spring around pivot axle 90 would immediately bias braking arm 88 into its operative braking position, in which it would project between rails 72, 72, straddling cable 80 by means of slot 84, to engage a transverse rung 67 of the pairs of rail sections 66. Thus, carriage 68 would only fall a very short distance, e.g. two feet—in any event at the most a distance equal to that between two vertically successive rungs 67, before being stopped by braking arm 88 engaging the next downwardly positioned rung 67.

It is to be understood that the presence of a braking system, such as braking system 81 disclosed herein, is important, considering that the carriage 68 will often be loaded with explosives for drilling the upper end of the mine raise. If the explosives were to fall a long distance to the bottom of the mine raise, an important accidental explosion could occur, possibly causing major human injuries or deaths.

The preferred material of the ladder assembly 20 is either steel or aluminium, or both. Any suitable rigid, impact and wear resistant material is envisioned however, which may be disassembled and reassembled on other mining sites. Preferably, the material will be as light as possible, therefor aluminium is a proper choice for many parts of ladder assembly 20, such as the ladder sections. However, some parts need to offer a greater load-bearing resistance, such as the cross-bars 24, which will preferably be made of a steel alloy, preferably stainless steel. Preferably, the carriage 68 will be made of a rigid plastic material, or will be coated with plastic material. Indeed, a metallic carriage would be likely to cause sparks which could ignite the explosives carried by carriage 68, with undesirable dire consequences. The carriage sliders 70, 70 are made of a low-friction material, preferably a plastic material such as polytetrafluoroethylene or nylon.

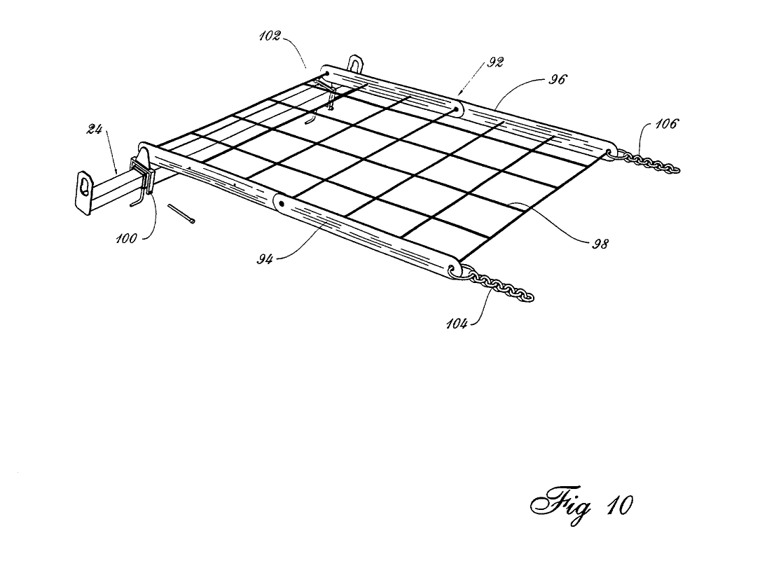

FIG. 10 shows a safety net 92 to be provided at the top end of ladder assembly 20, on the uppermost cross-bar 24. Net 92 comprises two pairs of parallel pivotable arms 94, 96 that allow same to collapse for transport or storage thereof, while arms 94, 96 can block in a fully extended position for supporting the wire meshing 98 of net 92 therebetween, as shown in FIG. 10. Support arms 94, 96 are supported at one end on cross-bar 24 by removable vises 100, 102, and are provided with support chains 104, 106 at their opposite outer free extremity, which are to be releasably attached to the mine raise peripheral wall. Safety net 92 being located on the uppermost cross-bar 24, it is located under the work platform from which the miners may accidentally fall, to prevent a miner from falling all the way to the bottom of the mine raise.

FIGS. 1, 2 and 3 show that ladder assembly 20 further comprises protective screens 108 which freely hang vertically downwardly from each cross-bar 24. Each protective screen 108 comprises a number of panel members 110, 110′, 110″, . . . vertically edgewisely attached by chain links or the like to form a substantially flat coextensive modular protective screen 108. The number of panel members 110, 110′, 110″ that form a protective screen 108 depends on the length which is selected therefor; thus, as each tier 22 has an adjustable length due to the length adjustment means provided on both the pairs of rail sections 66 and the ladder sections 38, each protective screen 108 has an adjustable length to fit tiers of different lengths.

The purpose of protective screens 108 is to provide a protection to the ladder assembly against falling rocks or other debris in the mine raise. They are positioned, as shown in FIG. 3, on the side opposite the side where the miners climb on ladder sections 38. Rocks falling in mine raise 10 would be likely to hit the peripheral wall 12, due to its inclination, and rebound against the protective shielding screens 108 to thus prevent the miners and the ladder assembly 20 from being hit thereby. It can be seen in FIG. 3 that the bottom edge of upper screen 108 will preferably come in horizontal register with the top edge of lower screen 108′, so as to cover substantially the whole vertical surface of the ladder assembly 20. Each panel member 110 can be made of a flexible, thick rubber sheet.

The ladder assembly of the present invention thus has many advantages:

a) it can be assembled easily in a mine raise, one tier at a time, for following the evolution of the mine raise as it increases in height during the mining operations;

b) it is made of sturdy material, and thus can resist impacts and support loads reliably;

c) the protective screens help to protect the miners and the ladder assembly efficiently;

d) each part is manufactured in the same reliable way, so that each be solid and sturdy; this is an important improvement, because the artisanal prior art ladder assemblies were often built in a relatively sturdy fashion, but often had one or more weaker zones, where the material was not as strong or where the attachment between several parts was weaker;

e) the carriage for carrying equipment therein helps to easily displace equipment to the top end of the mine raise, in a secure fashion;

f) erecting the ladder assembly requires almost no tools; indeed, each ladder section 38 and each pair of rail sections 66 may be installed without the use of tools; only the anchor rods 26, 28 for fixing the cross-bars to the mine raise peripheral wall 12 require tools;

g) it can be re-used in other mine raises once work in a first mine raise is over, since it will not be destroyed during removal operations.

Generally and as disclosed throughout the present specification, high priority has been awarded to the security of the present ladder assembly, considering the risks associated with the mining operations.

It is to be understood that any variations to the preferred embodiment of the present invention, which do not deviate from the scope thereof, are considered to be included therein.

For example, all length adjustment means could be removed on the different parts of the ladder assembly; this would make the ladder assembly 20 easier and less expensive to manufacture, but much more complex to install in a mine raise.

Also, the transverse cross-bars 24 could be replaced by other suitable transverse support members which accomplish the same purpose.

Also, the ladder sections 38 shown in the drawings are of conventional make, i.e. with a pair of parallel vertical studs holding a number of transverse rungs. Other suitable ladder sections could be provided, however, e.g. full panels with foot-receiving holes therein.

The ladder sections 38 could be attached to the cross-bars 24 elsewhere than at their upper ends 38b, e.g. at their lower ends or intermediate portions. However, the ladder section upper end attachment is the preferred means to carry out the invention, and probably the easier one as far as the assembly operation of the ladder assembly is concerned.

The brackets 40, 42 provided for attaching each ladder section to a corresponding cross-bar could be replaced by other suitable ladder attachment means, such as bolts or hooks integrally projecting from the ladder section engaging bores in the cross-bar. Also, it is understood that the attachment means can be provided on either one of the ladder section 38 and the cross-bar 24, as long as it releasably attaches one with the other. For example, brackets could be provided on the cross-bars 24, with the rungs of the ladder sections 38 being destined to rest on such brackets. Similar remarks apply to the brackets 40a, 42a of the pairs of rail sections 66.

The first and second coupling members 54, 56 and 58, 60 releasably attaching two vertically successive ladder sections to each other could also be of different make, e.g. pins in either the upper of lower ladder section engaging, under the bias of springs specifically provided therefor, bores in the other ladder section, whereby the release of the ladder sections from each other would be accomplished by digitally forcibly pushing the pins out of the bores of the said other ladder section.

Also, the length adjustment means for the ladder sections 38, the pairs of rail sections 66 and the cross-bars 24 could be different than those disclosed herein; e.g. each ladder section 38 could be made of a selected number of shorter modular sections that are attached to one another, each of these shorter sections comprising only one or several rungs.

The emergency braking system provided on the carriage can be the one disclosed herein, or any other suitable known emergency braking means, e.g. similar to those provided on elevators.

The protective screen could be made of a single vertically hanging sheet, which could be rolled upon itself for adjusting the length thereof.

The ladder sections could alternately be attached at their upper ends to a crossbar, and at their lower ends to the underlying crossbar, instead of being attached to the other ladder sections; or the ladder sections could be attached at their lower ends to a crossbar, and at their upper ends to the overlying ladder section. Generally, each ladder section comprises two ladder section attachment members, at least one of which is attached to a crossbar, with the other ladder section attachment member being attached to either another crossbar or another ladder section.

We claim:

1. A modular ladder assembly for upwardly inclined mine raises of the type having an open corridor with upper and lower ends and an irregular inner peripheral rock wall, comprising:
a number of transverse support members having a selectively operable length adjustment device;
anchoring members, for adjustable and releasable transverse attachment of said support members to the mine raise irregular peripheral rock wall in vertically spaced-apart, successive fashion;
a number of elongated ladder sections defining upper and lower ends and each being positioned adjacent at least one said support member;
ladder sections attachment members, integral to a selected one of each said ladder section and each said support member, each said ladder sections attachment member releasably attaching each said ladder section to a corresponding said support member;
a first coupling member, integral to the upper end of each said ladder section; and
a second coupling member, integral to the lower end of each said ladder section and matingly releasably attachable to said first coupling member of an underlying other said ladder section;
wherein a continuous ladder assembly can be gradually formed in a mine raise by end to end attachment of successive said ladder sections, with said crossbars supporting said ladder sections, and wherein said ladder assembly can be removed from said mine raise to be used in other mine raises.

2. A ladder assembly as defined in claim 1, wherein said support members are transverse elongated cross-bars having two opposite ends having attachment portions for fixed attachment thereof to the mine raise peripheral rock wall.

3. A ladder assembly as defined in claim 2, wherein said length adjustment device of each said cross-bar includes at least two portions in said cross-bar that are telescopingly engaged.

4. A ladder assembly as defined in claim 3, wherein each said cross-bar includes a main elongated sleeve bar having two opposite open ends and a first and a second bars slidable inside said sleeve bar and outwardly extending through a corresponding one of said first and second open ends; and fixing members for selectively releasably setting the respective positions of said arms relative to said sleeve bar.

5. A ladder assembly as defined in claim 1, wherein the length of each said ladder section can be selectively adjusted.

6. A ladder assembly as defined in claim 5, wherein each said ladder section has a pair of opposite lateral studs defining upper and lower end portions and a plurality of spaced transverse rungs, and further including an intermediate sleeve member wherein said upper and lower end portions of said ladder section studs are slidable in said sleeve member and extend upwardly and downwardly thereof respectively; and further comprising fixing members for selectively releasably setting the respective positions of said upper and lower end portions of said ladder sections relative to said sleeves.

7. A ladder assembly as defined in claim 2, wherein said ladder attachment members are brackets formed of flat rigid C-shaped plates fixedly attached to the upper end of each said ladder section, for secure abutment of said ladder section against a corresponding cross-bar, with each said cross-bar having a rectangular cross-section to allow said brackets to matingly abut complementarily thereover in a hooking fashion, whereby the downward engagement of said C-shaped bracket over and partly around an underlying said cross-bar prevents movement of said ladder section relative to said cross-bar in all directions except upwardly lengthwisely of the ladder section.

8. A ladder assembly as defined in claim 7, wherein a complementary pair of said first and second coupling members each comprises a corresponding one of a female and a male end matingly engageable with each other in a releasable attachment that allows relative angular positioning of two successive ladder sections attached to each other about an axis substantially parallel to an adjacent said cross-bar.

9. A ladder assembly as defined in claim 1, further comprising:
a number of integral pairs of spaced parallel elongated rail sections, each of said pairs defining upper and lower ends and being positioned adjacent at least one said support member;
rail attachment members attached to either one of each said pairs of rail sections and each said support members, for removably attaching each said pairs of rail sections to a corresponding said support member;
a third coupling member attached to the upper end of each said pair of rail sections;
a fourth coupling member attached to the lower end of each said pair of rail sections and matingly releasably attachable to said third coupling member of an underlying rail section;
whereby a continuous modular rail can be formed by a number of rail sections releasably attached to one another in successive pairs coupled end to end, said continuous rail being secured to said support members by said rail attachment members;
said ladder assembly further comprising:
a carriage movable along said rails, said carriage including a load carrying housing; and
a carriage displacement device, for supporting and moving said carriage along said continuous rail.

10. A ladder assembly as defined in claim 9, wherein said third and fourth coupling members include pivots allowing relative angular positioning of two successive pairs of rail sections about an axis substantially parallel to and adjacent said support member.

11. A ladder assembly as defined in claim 10, wherein said carriage comprises a main body and a pair of sliders attached to said main body and engaging said continuous rail so as to be movable therealong, and wherein each rail section of a said integral pair of rail sections has longitudinally inturned flanges that cradle over one of said carriage sliders for preventing accidental disengagement of said carriage sliders from said rails while allowing free sliding movement of said sliders along said continuous rail.

12. A ladder assembly as defined in claim 11, wherein said carriage main body defines first and second opposite ends and comprises a pair of link arms each pivotally attached to both said main body first end and to a corresponding said carriage slider, and wherein said displacement device is a cable attached to a top end of said carriage for upwardly pulling said carriage along said rails.

13. A ladder assembly as defined in claim 12, wherein said carriage comprises an emergency braking system, for preventing high velocity downward movement of said carriage upon accidental rupture or release of said cable.

14. A ladder assembly as defined in claim 1, further comprising a flexible protective screen, edgewisely attached to each said support member and freely hanging therefrom, for protecting the ladder assembly therebehind from falling rocks or other debris detaching from the peripheral rock wall ahead thereof.

15. A ladder assembly as defined in claim 14, wherein said protective screen comprises several vertical panel members edgewisely interconnected in successive pairs to form a substantially flat modular protective screen, whereby the length of said protective screen may be adjusted in accordance with the size of the ladder assembly by selecting the number of panel members forming said protective screen.

16. A ladder assembly as defined in claim 1, further comprising a safety sheet net releasably carried by and horizontally extending from the uppermost support member so as to extend substantially horizontally.

17. A kit for the assembly of a modular ladder assembly in an ascending mine raise having a peripheral wall, said kit comprising:
a plurality of crossbars adapted to be installed transversely inside the mine raise, each said crossbar including a length adjustment device and anchoring members for releasably anchoring said crossbars to the mine raise peripheral wall;
a plurality of elongated ladder sections, each said ladder section defining two opposite ends and comprising:
a first ladder section attachment member adapted to releasably attach in use said ladder section to a corresponding said crossbar installed inside the mine raise, whereby a first ladder section attachment point is obtained, said first ladder section attachment member being carried at one of said ladder section ends;
a second ladder section attachment member adapted to releasably attach in use said ladder section to either one of an adjacent said crossbar and an adjacent said ladder section whereby a second ladder section attachment point is obtained, said second ladder section attachment member being located at said ladder section end opposite said first ladder section attachment member;
wherein said kit is adapted in use to form a ladder assembly inside the mine raise by the co-extensive installation of a number of said ladder sections supported by said crossbars.

18. A kit for the assembly of a modular ladder assembly in an ascending mine raise having a peripheral wall and an upper end, said kit comprising:
a plurality of crossbars adapted to be installed transversely inside the mine raise, each said crossbar including a length adjustment device and anchoring members for releasably anchoring said crossbars to the mine raise peripheral wall;
a plurality of elongated ladder sections, each said ladder section defining first and second opposite ends and comprising:
a ladder section attachment member carried at said ladder section first end adapted to releasably attach in use said ladder section to a corresponding said crossbar installed inside the mine raise;
a first coupling member integrally attached at said ladder section first end; and
a second coupling member integrally attached at said ladder section second end and adapted to releasably engage in use said first coupling member of another ladder section for releasable attachment of said first and second coupling members;
wherein said kit is adapted in use to form a ladder assembly inside the mine raise by the co-extensive installation of a number of said ladder sections releasably attached to one another in end to end relationship and supported by said crossbars.

19. A kit as defined in claim 18, wherein the length of each said ladder section is adjustable.

20. A kit as defined in claim 19, further comprising a plurality of protective screens adapted in use to each be attached to a corresponding crossbar to freely hang therefrom for protecting an adjacent ladder section from falling debris.
